(19) United States
(12) Patent Application Publication
(10) Pub. No.: US 2006/0083242 A1
(43) Pub. Date: Apr. 20, 2006

(54) Address modification in application servers

(75) Inventor: Olli M. Pulkkinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/993,515

(22) Filed: Nov. 22, 2004

(30) Foreign Application Priority Data
Oct. 20, 2004 (EP) 04024989.8

(51) Int. Cl. H04L 12/28; H04L 12/56

(52) U.S. Cl. 370/392; 370/400

(57) ABSTRACT

The present invention relates to a method and system for modifying of address information in a message routed in a packet data network, wherein the address information is changeable along a routing path of the message. In case of a change of the address information, information specifying a reason for the changed address information is added to the message, and a processing of the message is selected at a session control function based on the added information. This allows for address change operations, such as number modifications or access code additions, even in cases where an address change is generally interpreted by the session control function as a call forwarding operation.

### FIELD OF THE INVENTION

The present invention relates to a method and system for modifying an address information in a server device of a packet switched network, such as an Internet Protocol (IP) Multimedia Subsystem (IMS) provided on top of a packet switched network to offer voice and multimedia services e.g. for third generation mobile devices, or any other packet switched network.

### BACKGROUND OF THE INVENTION

The Session Initiation Protocol (SIP) as defined in the Internet Engineering Task Force (IETF) specification RFC 3261, provides an emerging standard for setting up multimedia sessions on the Internet. Its basic capabilities are setup, modification and tear-down of any communication session, so it is a signaling protocol. SIP also provides personal mobility, meaning that a subscriber is reachable via a single address regardless of its current point of attachment to the network.

SIP is used to establish, modify and terminate sessions as well as send and receive transactions. It provides personal mobility by allowing a user to dynamically register to the network with his communication address, i.e. SIP URI (Uniform Resource Indicator). A session is usually one or more Real-time Transport Protocol (RTP) streams to be exchanged. Normally, a session comprises speech, audio or video streams or a combination of them, but it may also contain shared applications. SIP uses an address format common to Internet Mail, i.e. “user@domain”. The domain part is used to find the correct domain for the subscriber and the user part is used to distinguish between individual subscribers within a domain. SIP includes request and response messages comprising header fields, e.g. for defining where the request is to be sent next, the recipient address, the sender address etc. Furthermore, a SIP message may contain a payload portion for transmitting subscriber or service specific information.

IMS (IP Multimedia Subsystem) is specified by the 3rd Generation Partnership Project (3GPP), e.g. in its specification TS 23.228, as an access independent subsystem which can be used in connection with different networks. IMS uses SIP for session initiation. Basically IMS is just an instance of a SIP network. A user agent (UA) is situated in the terminal device or user equipment (UE). When two devices establish a session the signaling is passed via call state control function (CSCF) elements. An S-CSCF is always located in the subscriber's home domain and takes the role of a SIP registrar and/or proxy server, so that the UE can be registered at the S-CSCF using SIP. The S-CSCFs can be dynamically allocated per registration in order to achieve efficient load balancing and error residency. Furthermore, an application server (AS) is provided as a SIP element dealing with the services provided to the UE. Several ASs can be provided for different purposes. An S-CSCF forwards requests to the AS based on filter criteria of a user. Filter criterias determine the services that will be provided to each user. Finally, a Home Subscriber Server (HSS) is arranged for profile management and authentication.

Based on its actual function or usage, the S-CSCF can be divided further into an originating call state control function (O-S-CSCF) and a terminating call state control function (T-S-CSCF) at the originating and terminating ends of a session, respectively. In an 3GPP Release 6 IMS network, the AS is only able to modify a Request-URI (R-URI) of SIP message for the purpose of call forwarding. The modification of the R-URI in a SIP message is then checked/detected at the S-CSCF and understood in a sense that the AS has made a call forwarding. However, the current 3GPP standards don't provide enough means for the AS to do number modification for other purpose than call forwarding. In particular, the AS is not able to intoduce number modification, e.g. by adding a carrier access code (CAC) to the R-URI of a SIP message. Rather, the S-CSCF will understand the change of the R-URI of the SIP message as call forwarding and will terminate execution of the subscriber's service(s) in order to route the respective message forward. Hence, when the AS modifies the R-URI for the purpose of call forwarding, the execution of the subscriber's services in the S-CSCF is terminated.

### SUMMARY OF THE INVENTION

It is therefore an object of the present invention to provide a method and system for allowing number or address modification on the routing path of a message without initiating a call forwarding process.

This object is achieved by a method of modifying an address information in a message routed in a packet switched network, said method comprising the steps of:

changing said address information along a routing path of said message;

adding to said message an information specifying a reason for said changed address information; and

selecting a processing of said message at a controlling function based on said added information.

Furthermore, the above object is achieved by a server for providing a service in a packet switched network, said server comprising:

address change means for changing an address information in a header portion of a received message; and

adding means responsive to said address change means for adding to said received message an information specifying a reason for said changed address information.

Finally, the above object is achieved by a control device for performing session control in a packet switched network, said control device comprising:

detecting means for detecting an information specifying a reason for a changed address information in a header portion of a received message; and

selecting means for selecting a subsequent processing of said received message in response to a detection output of said detecting means.

Accordingly, the problem of wrong interpretation of an address change can be prevented by adding an information to the message, which specifies a reason for the address change. Any subsequent network node or network device can thus identify or determine which processing is to be initiated as a response to the detected address change. This allows introduction of new service features which require address changes, e.g. it enables server devices to modify the address information in such a way that execution of subscriber's services is not terminated or effected in a wrong manner in a subsequent device. Execution of subscriber services can thus continue after number modification, e.g. after private numbering plan (PNP) translation or CAC addition.

According to a first option, the added information may be a parameter of a uniform resource indicator which comprises the changed address information.

As an alternative or additional second option, the added information may be provided in an additional header of the message. Then, the additional header may comprise the original unmodified address information.

The processing may be selected from the options of continuing and terminating a subscriber service related to said address information.

Furthermore, the message may be a signaling message used to established a communication connection.

The server may comprise forwarding means for forwarding the message to a control entity. Additionally, the server may comprise service logic means for providing services to users of the packet switched network, wherein the service logic means are configured to use the address change means. As an example, the service logic means may be configured to provide the users with centrex services.

The adding means may be configured to add one of following reasons: private numbering plan change, carrier access code insertion, call forwarding, service number change, and number portability.

The control device may comprise forwarding means for forwarding a message to a service providing entity, wherein the detecting means are configured to detect the reason for changed address information when the message is returned from the service providing entity. The forwarding means may be configured to forward the message to the service providing entity based on filtering rules.

Other advantageous developments of the present invention are defined in the dependent claims.

### BRIEF DESCRIPTION OF THE DRAWINGS

The present invention will now be described on a basis of preferred embodiments with reference to the accompanying drawings, in which:

FIG. 1 shows an IMS network architecture in which the present invention can be implemented;

FIG. 2 shows a schematic signalling diagram of a number modification processing according to a first preferred embodiment;

FIG. 3 shows a schematic flow diagram of a checking operation according to the first preferred embodiment;

FIG. 4 shows a schematic signalling diagram of a number modification processing according to a second preferred embodiment; and

FIG. 5 shows a schematic flow diagram of a checking operation according to the second preferred embodiment.

### DESCRIPTION OF THE PREFERRED EMBODIMENTS

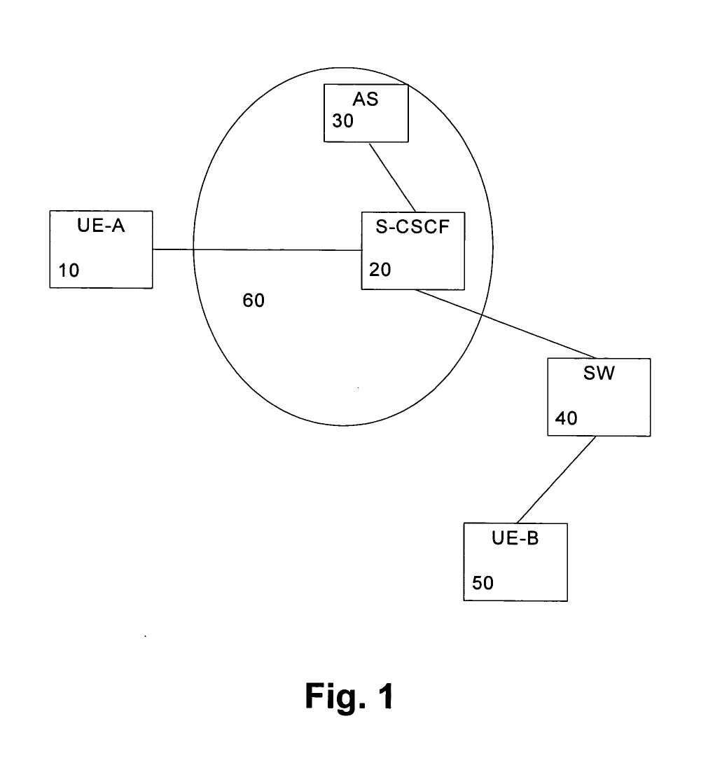

The preferred embodiments will now be described on the basis of an IMS network architecture as shown in FIG. 1.

FIG. 1 shows a schematic block diagram of an exemplary IMS network architecture in which the present invention can be implemented. In an IMS network 60, an S-CSCF 20 is a SIP Proxy providing services offered by an AS 30 for a user equipment A (UE-A) 10 of a user or subscriber A. As an example, the AS 30 may implement an IP Centrex functionality to provide Centrex services to IMS users. At the other transmission end, the switch 40 may provide a connection to another UE-B 50 which may be another IMS user or an analog or digital telephone set connected via an analog or digital network.

From the IMS point of view the IP Centrex functionality corresponds to an AS which uses an IP Multimedia Service Control (ISC) interface. However, the AS 30 performs number modifications from IMS addresses into Centrex numbers. The AS 30 may have an interface to a Home Subscriber Server (HSS, not shown). The HSS contains all user-related subscription data required to handle multimedia sessions, including user profile information and the services the user is subscribed to. The S-CSCF 20 and the AS 30 may receive this data from the HSS over Cx and Sh interfaces.

According to the first preferred embodiment, a misinterpretation of the above number modification by the AS 30 is prevented by having the AS 30 add a parameter to the R-URI of the SIP message so as to indicate the reason for modification. That way, the S-CSCF 20 can discriminate between number modification and conventional call forwarding. Call forwarding can be one of the reasons for modification.

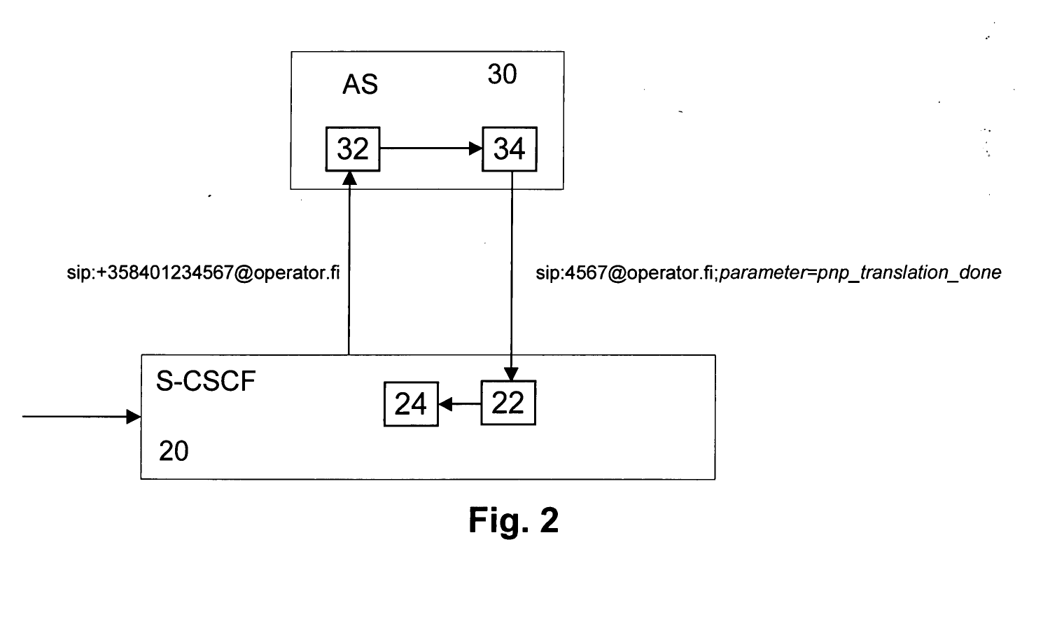

FIG. 2 shows a schematic diagram indicating a signalling between the S-CSCF 20 and the AS 30 according to the first preferred embodiment. The S-CSCF 20 forwards a SIP message with R-URI (+358401234567@operator.fi) to the AS 30, where it is supplied to an address change function or unit 32 if a number modification is performed. The address change function may be based on a memory table which stores number or address relationships or associations. In the example of FIG. 2, the user number in the R-URI is changed to “4567”.

In response to such a number modification, an adding function or unit 34 adds or inserts to the R-URI a parameter indicating or specifying a reason for the number modification. This addition may be based on a control signal received from the address change function 32 or on an own change detection function provided at the adding function 34. In the example of FIG. 2, the parameter adding function 34 adds the information “parameter=pnp_translation_done” to indicate that the number modification was the result of a PNP translation. Of course, other parameter values such as binary codes, decimal numbers, characters or the like could be used as well for signalling the reason for the number modification.

The S-CSCF 20 receives the message with the modified R-URI and detects the changed number and the added parameter at a checking function or unit 22, e.g., based on a predetermined evaluation of the R-URI information. If no parameter has been added, i.e. if a simple call forwarding has been initiated, the changed address or number can be detected based on a comparison with a previously stored former number . . . In response to a detection of a change or modification, the address checking function 22 supplies a control signal or control information to a selection function or unit 24 which selects a processing so as to continue or discontinue execution of the subscriber's service.

The AS 30 may also indicate call forwarding as a reason for number modification. In this case, the S-CSCF 20 should operate as in normal call forwarding case. Other reason codes may be, for example, private numbering plan translation, number portability (ported number), carrier access code/operator identification code inserted, service number translation (e.g. 0800-xxx service number translated to normal number), call redirection/forwarding.

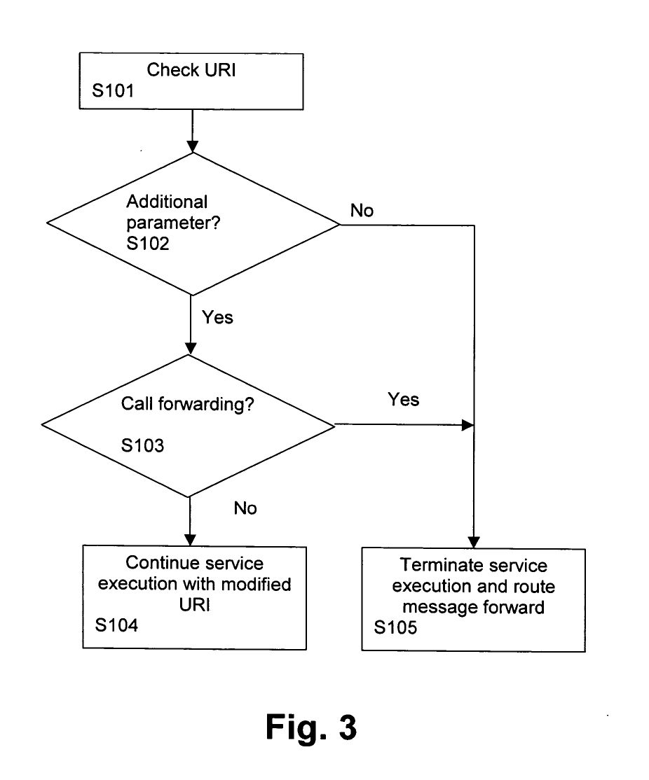

FIG. 3 shows a schematic flow diagram of the basic processing steps at the S-CSCF 20 according to the first preferred embodiment. In step S101, the R-URI is checked at the address checking function 22. Based on the checking result, i.e. if a changed or modified URI with an additional parameter is provided, it is further checked by the address checking function 22 in step S103 whether the reason indicated by the additional parameter is call forwarding. If not, it is decided in step S103 to proceed with step S104 and continue service execution with modified URI. Otherwise, it is decided to proceed with step S105, terminate service execution and route the message forward in accordance with the call forwarding number or address. The latter case also applies if it is detected in step S102 that the modified URI is provided with no additional parameter.

According to the second preferred embodiment, a misinterpretation of the number modification by the AS 30 is prevented by having the AS 30 add an additional header to the SIP message so as to indicate the reason for modification. Furthermore, as an option, the header may as well include the original unmodified number or address. That way, the S-CSCF 20 can again discriminate between number modification and conventional call forwarding.

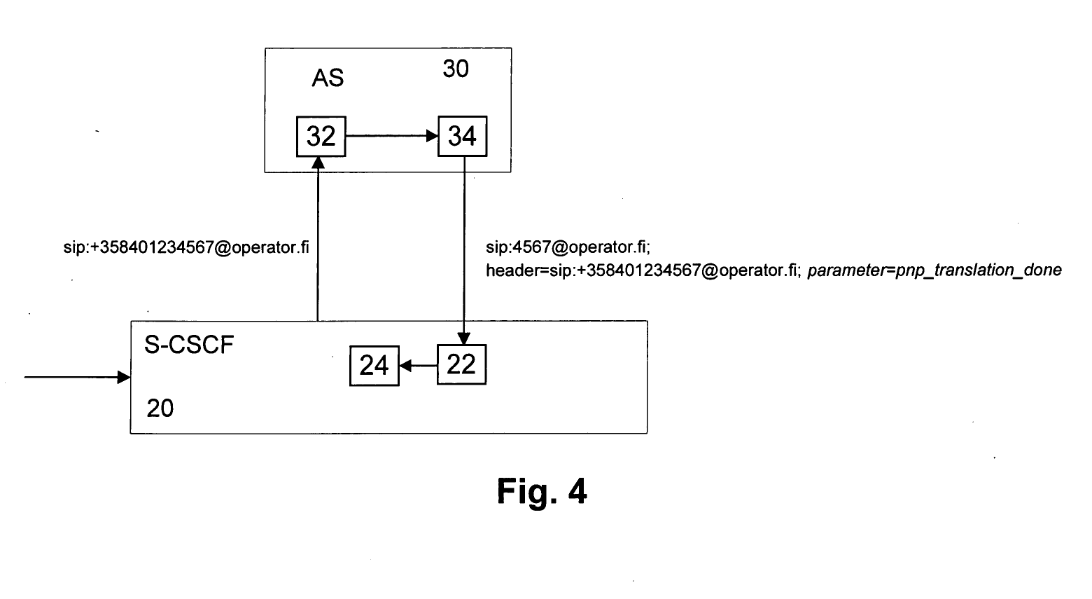

FIG. 4 shows a schematic diagram indicating a signalling between the S-CSCF 20 and the AS 30 according to the second preferred embodiment. Similar to the first preferred embodiment, the S-CSCF 20 forwards the SIP message with R-URI (+358401234567@operator.fi) to the AS 30, where it is supplied to the address change function or unit 32 if a number modification is performed. As in the example of FIG. 2, the user number in the R-URI is changed to “4567”.

In response to the number modification, the adding function or unit 34 now adds or an additional header which comprises the above parameter indicating or specifying a reason for the number modification and the original unmodified R-URI. This addition may again be based on a control signal received from the address change function 32 or on an own change detection function provided at the adding function 34. In the example of FIG. 2, the adding function 34 adds a header with the information “+358401234567@operator.fi; parameter=pnp_translation_done” to indicate that the original number and that the number modification was the result of a PNP translation. Here also, other parameter values such as binary codes, decimal numbers, characters or the like could be used as well for signalling the reason for the number modification.

The S-CSCF 20 receives the message with the additional header and detects the changed number and the added header at the address checking function or unit 22, e.g., based on a predetermined evaluation of the message header. If no header has been added, i.e. if a simple call forwarding has been initiated, the changed address or number can again be detected based on a comparison with a previously stored former number or based on checking the unmodified number present in the additional header. In response to a detection of a change or modification, the address checking function 22 supplies a control signal or control information to a selection function or unit 24 which selects a processing so as to continue or discontinue execution of the subscriber's service.

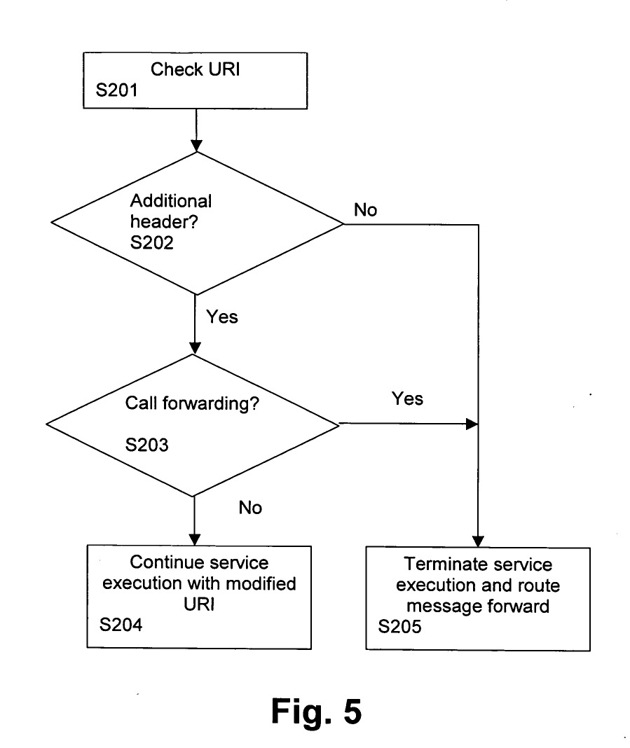

FIG. 5 shows a schematic flow diagram of the basic processing steps at the S-CSCF 20 according to the first preferred embodiment. In step S201, the URI is checked at the address checking function 22. If the checking result indicates that a modified URI with an additional header is provided, it is checked in step S203 whether a parameter of the new header indicates call forwarding as the reason for modification. If not, it is decided in step S203 to proceed with step S204 and continue service execution with modified URI. Otherwise, it is decided to proceed with step S205 and terminate service execution and route the message forward in accordance with the call forwarding number or address. The latter case also applies if it is detected in step S202 that the modified URI is provided with no additional header.

In summary, method and system for modifying of an address information in a message routed in a packet switched network has been described, wherein the address information can be changed along a routing path of the message. In case of a change of the address information, an information specifying a reason for the changed address information is added to the message, and a processing of the message is selected at a session control function, e.g. an S-CSCF, based on the added information. This allows for address change operations, such as number modifications or access code additions, even in cases where an address change is generally interpreted by the session control function as a call forwarding operation.

The invention may also be used to provide IMS users with services from the circuit switched network. In this embodiment one of the circuit switched network elements, such as MSC (Mobile Services Switching Centre) or MGCF (Media Gateway Control Function), is acting as an application server for IMS network and may interface the IMS over ISC interface. The MSC and MGCF may implement traditional circuit switched network services, including digit analysis, number translation, number portability etc. The MSC and MGCF may further connect an IN (Intelligent Network) SCP (Service Control Point) which may implement various IN services which are well known to a man skilled in the art. Some of these services may implement number modifications. In the embodiment of the invention, a service-providing element, such as MSC, may indicate the reason for number modification over the ISC interface to the S-CSCF according to the description of the above preferred embodiments.

It is noted that the present invention is not restricted to the preferred embodiments and the IMS architecture described above. The present invention may be implemented in any server device or node having in which a modification of an address information can be made. Moreover, the checking and selective processing can be initiated in any call or session control device. In particular, any address information in header or payload fields of any packet data message or datagram may modified in connection with an address information. In general, the present invention is intended to cover any addition of an information about a reason of change, if an address information in a message has been changed. The embodiments may thus vary within the scope of the attached claims.

1. A method of modifying address information in a message routed in a packet switched network, said method comprising the steps of:
changing said address information along a routing path of said message;
adding to said message information specifying a reason for said changed address information; and
selecting a processing of said message at a controlling function based on said added information.

2. A method according to claim 1, wherein said added information is a parameter of a uniform resource indicator, which comprises said changed address information.

3. A method according to claim 1, wherein said added information is provided in a header of said message.

4. A method according to claim 3, wherein said header comprises the address information unchanged.

5. A method according to claim 1, wherein said changed address information is a user number changed in connection with a number modification processing.

6. A method according to claim 5, wherein said number modification processing is a private numbering plan translation.

7. A method according to claim 5, wherein said number modification processing is a carrier access code addition.

8. A method according to claim 1, wherein said message is a session initiation protocol message.

9. A method according to claim 1, wherein said processing is selected from options of continuing or terminating a subscriber service related to said address information.

10. A method according to claim 1, wherein said message is a signaling message to establish a communication connection.

11. A server for providing a service in a packet switched network, said server comprising:
address change means for changing address information in a header of a received message; and
adding means responsive to said address change means for adding to said received message information specifying a reason for said changed address information.

12. A server according to claim 11, further comprising:
forwarding means for forwarding said received message to a control entity.

13. A server according to claim 11, further comprising:
service logic means for providing services to users of said packet switched network, wherein the service logic means is configured to use said address change means.

14. A server according to claim 13, wherein said service logic means is configured to provide said users with centrex services.

15. A server according to claim 11, wherein said adding means is configured to add one of following reasons: a private numbering plan change, a carrier access code insertion, call forwarding, a service number change, or number portability.

16. The server according to claim 11, wherein said adding means is adapted to add said information as an additional parameter of a uniform resource indicator, which comprises said changed address information.

17. The server according to claim 11, wherein said adding means is adapted to add said information to an additional header of said message.

18. The server according to claim 17, wherein said additional header comprises the address information unchanged.

19. A control device for performing session control in a packet switched network, said control device comprising:
detecting means for detecting information specifying a reason for changed address information in a header portion of a received message and for outputting a detection output indicative thereof; and
selecting means for selecting a subsequent processing of said received message in response to the detection output of said detecting means.

20. A control device according to claim 19, further comprising:
forwarding means for forwarding a message to a service providing entity, wherein said detecting means is configured to detect said reason for the changed address information when the message is returned from said service providing entity.

21. A control device according to claim 20, wherein said forwarding means is configured to forward said message to said service providing entity based on filtering rules.

22. A control device according to claim 19, wherein said selecting means is adapted to select said subsequent processing from options of continuing or terminating a subscriber service.

23. A control device according to claim 19, wherein said control device is arranged to perform a call state control function in an IMS network.

24. A system for modifying address information in a header of a message routed in a packet data network, said system comprising a server device for providing a service in a packet switched network, said server comprising:
address change means for changing address information in a header of a received message; and
adding means responsive to said address change means for adding to said received message information specifying a reason for said changed address information.

25. A system for modifying address information in a header of a message routed in a packet data network, said system comprising a control device for performing session control in a packet switched network, said control device comprising:
detecting means for detecting information specifying a reason for changed address information in a header of a received message and for outputting a detection output indicative thereof; and
selecting means for selecting a subsequent processing of said received message in response to the detection output of said detecting means.
